(19) United States
(12) Patent Application Publication
(10) Pub. No.: US 2009/0321586 A1
(43) Pub. Date: Dec. 31, 2009

(54) Cable Retainer

(75) Inventors: Zbigniew Kabat, Schaumburg, IL (US); Gary P. Ohm, Chicago, IL (US)

Correspondence Address: Jay M. Brown, 6409 Fayetteville Road, Suite 120-306, Durham, NC, 27713, US

(73) Assignee: LUCENT TECHNOLOGIES INC., Murray Hill, NJ (US)

(21) Appl. No.: 12/165,650

(22) Filed: Jun. 30, 2008

(51) Int. Cl. F16L 3/02; E04C 2/52; E04B 1/00

(52) U.S. Cl. 248/49; 52/220.1; 52/741.1

(57) ABSTRACT

Device including flexible main sheet, two fold regions, and two flexible flap sheets. Main sheet has first and second opposite sides and edge surrounding sides. Fold regions are located along two spaced-apart portions of edge. Each flap sheet has first and second opposite sides. Flap sheets are integrated with main sheet at fold regions. Flap sheets are configured for being bent toward first side of main sheet. Main sheet is configured for being bent to move fold regions toward each other, while retaining bias for moving fold regions away from each other. Apparatus including trough and device. Trough includes base member integrated with two spaced-apart wall members forming side walls in trough. One side of each flap sheet in contact with a side wall. Main sheet is bent with fold regions at least partially positioned toward each other, and configured for retaining bias for moving fold regions away from each other. Methods also provided.

### BACKGROUND OF THE INVENTION

1. Field of the Invention

This invention generally relates to cable retention devices and methods.

2. Related Art

This section introduces aspects that may help facilitate a better understanding of the invention. Accordingly, the statements of this section are to be read in this light and are not to be understood as admissions about what is prior art or what is not prior art.

Various types of devices have been developed for supporting and maintaining order among fiber optic and metallic conductor cables. Systems utilizing such cables often include guides for the cables. Despite these developments, there is a continuing need for improved devices and apparatus capable of supporting, protecting, and maintaining order among fiber optic and metallic conductor cables.

### SUMMARY

In an example of an implementation, a device is provided, including a flexible main sheet, two fold regions, and two flexible flap sheets. The main sheet has first and second opposite sides, and has an edge surrounding both of the first and second sides. The two fold regions are respectively located along two spaced-apart portions of the edge. Each of the flap sheets has first and second opposite sides; and the two flap sheets respectively are integrated with the main sheet at the two fold regions. Both of the flap sheets are configured for being bent toward the first side of the main sheet. The main sheet is configured for being bent to move the two fold regions toward each other, while retaining a bias for moving the two fold regions away from each other.

As another example of an implementation, an apparatus is provided. The apparatus includes a trough, and a device that includes a flexible main sheet, two fold regions, and two flexible flap sheets. The trough includes a base member integrated with two spaced-apart wall members, and each of the wall members forms a side wall in the trough. The main sheet has first and second opposite sides, and the main sheet has an edge surrounding both of the first and second opposite sides. Each of the two flap sheets has first and second opposite sides. The two fold regions respectively are located along two spaced-apart portions of the edge. The two flap sheets respectively are integrated with the main sheet at the two fold regions. The first sides of the two flap sheets are respectively in contact with the two side walls of the trough. Further, the main sheet is bent, with the fold regions at least partially positioned toward each other; and the main sheet is configured for retaining a bias for moving the fold regions away from each other.

In a further example of an implementation, a method is provided. The method includes providing a cable carrier having first and second adjoining troughs, placing a cable in the first trough, providing a device including a flexible main sheet, bending the main sheet, and placing the main sheet over the cable in the first trough. Providing the cable carrier includes providing a base member integrated with first and second spaced-apart side wall members, the carrier including a central wall member on the base member between the side wall members, the first side wall member and the central wall member each forming a side wall in the first trough. The main sheet has first and second opposite sides, and has an edge surrounding both of the first and second sides. Bending the main sheet includes moving two spaced-apart portions of the edge at least partially toward each other. Placing the main sheet over the cable in the first trough includes placing one of the two spaced-apart portions of the edge in contact with each of the side walls in the first trough.

As an additional example of an implementation, another method is provided. The method includes providing a cable carrier having a trough, placing a cable in the trough, providing a device including a flexible main sheet, bending the main sheet, and placing the main sheet over the cable in the trough. Providing the cable carrier includes providing a base member integrated with first and second spaced-apart side wall members each forming a side wall in the trough. The main sheet has first and second opposite sides, and has an edge surrounding both of the first and second sides. Bending the main sheet includes moving two spaced-apart portions of the edge at least partially toward each other. Placing the main sheet over the cable in the trough includes placing one of the two spaced-apart portions of the edge in contact with each of the side walls in the trough.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view showing an example of an implementation of a device.

FIG. 2 is a plan view of the device shown in FIG. 1.

FIG. 3 is another plan view of the device shown in FIGS. 1 and 2.

FIG. 4 is a perspective view showing an example of an implementation of an apparatus.

FIG. 5 is a cross-sectional view taken along line A, showing the apparatus of FIG. 4.

FIG. 6 is a flow chart showing an example of an implementation of a method.

FIG. 7 is a flow chart showing another example of the method.

### DETAILED DESCRIPTION

Modern central office telecommunications systems frequently contain significant numbers of signal and power cables, generally including both metallic conductor cables and fiber optic cables. Placing and keeping these signal and power cables in orderly arrangements may be a challenge for system installers as well as for repair- and maintenance-technicians. Trough-shaped apparatus are often integrated with the telecommunications systems to provide pathways for supporting and guiding the cables. However, repair and maintenance operations may involve removing, replacing and adding cables, which may, for example, necessitate moving some cables in order to obtain access to other cables. Moving cables around may lead to disorganizing an original cable installation scheme, adding difficulty to subsequently locating particular cables for maintenance. Since fiber optic cables may be relatively fragile, minimizing their movement, removal and other disturbances during the service life of the telecommunications systems may be important in reducing needed cable replacements. These same issues may likewise develop in telecommunications equipment other than central office telecommunications systems, and in non-telecommunications systems including both signal and power cables, such as fiber-optic and metallic conductor cables. Devices, apparatus including devices, and methods are accordingly provided herein, which may, as examples, facilitate segregation of signal and power cables such as between fiber optic and metallic conductor cables, retention of signal and power cables in orderly arrangements, and minimization of movement of certain signal and power cables when the movement of other cables is carried out.

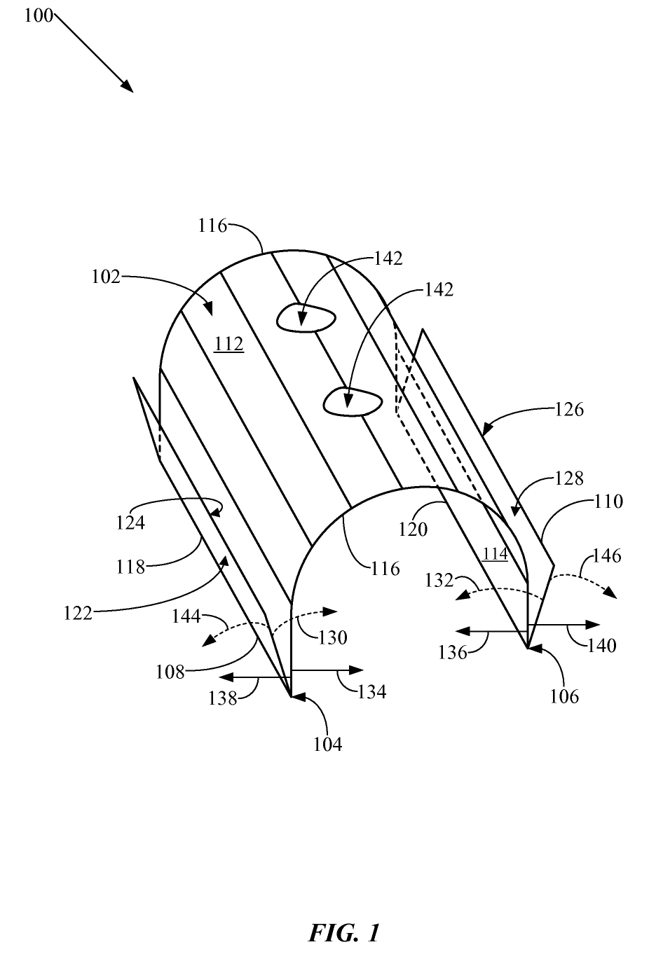

FIG. 1 is a perspective view showing an example of an implementation of a device 100, including a main sheet 102, two fold regions 104, 106, and two flap sheets 108, 110. The main sheet 102 is flexible and has first and second opposite sides 112, 114. The main sheet 102 also has an edge 116 surrounding both of the first and second sides 112, 114. The two fold regions 104, 106 are respectively located along two spaced-apart portions 118, 120 of the edge 116. Each of the two flap sheets 108, 110 is flexible. The flap sheet 108 has first and second opposite sides 122, 124, and the flap sheet 110 has first and second opposite sides 126, 128. The flap sheets 108, 110 respectively are integrated with the main sheet 102 at the two fold regions 104, 106. The flap sheets 108, 110 are respectively configured for being bent along directions represented by arrows 130, 132 toward the first side 112 of the main sheet 102. The main sheet 102 is configured for being bent to move the two fold regions 104, 106 toward each other along directions represented by arrows 134, 136. The main sheet 102 is also configured for retaining a bias for moving the two fold regions 104, 106 away from each other along directions represented by arrows 138, 140. As an example, the main sheet 102 may include a grip 142 spaced apart from the edge 116 and located on the first side 112 of the main sheet 102, the grip 142 being configured for applying a pulling force to the first side 112 of the main sheet 102. For example, the grip 142 may include one or more apertures 142, each aperture 142 being spaced apart from the edge 116 and communicating with the first and second opposite sides 112, 114 of the main sheet 102. As further examples (not shown), the grip 142 may include a ring attached to the main sheet 102 and having an aperture oriented generally perpendicular to the first side 112, or a handle attached to the main sheet 102.

It is understood by those skilled in the art throughout this specification that the term “flexible” designates a sheet-like material having sufficient flexibility for manual bending back and forth. As examples, a polymeric plastic material or a metal material such as spring steel may be utilized.

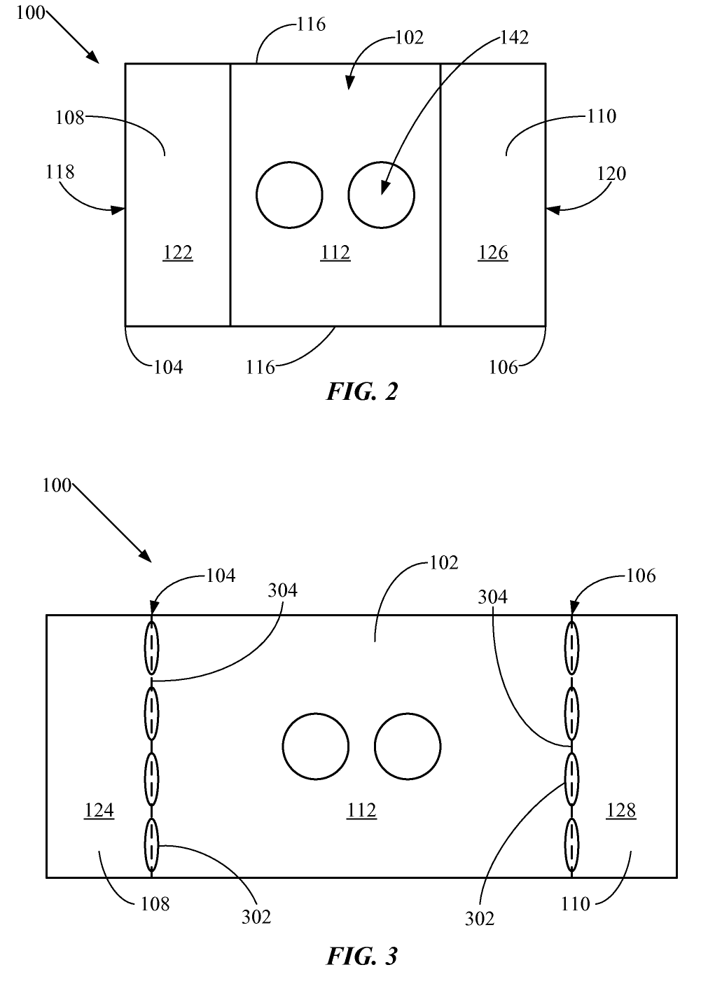

FIG. 2 is a plan view of the device 100 shown in FIG. 1. The device 100 includes a main sheet 102, two fold regions 104, 106, and two flap sheets 108, 110. The main sheet 102 is flexible and has first and second opposite sides including a first side 112, and a second opposite side 114 shown in FIG. 1. The main sheet 102 also has an edge 116 surrounding the main sheet 102. The two fold regions 104, 106 are respectively located along two spaced-apart portions 118, 120 of the edge 116. Each of the two flap sheets 108, 110 is flexible. The flap sheet 108 has first and second opposite sides including a first side 122, and a second side 124 shown in FIG. 1. The flap sheet 110 has first and second opposite sides including a first side 126, and a second side 128 shown in FIG. 1. The flap sheets 108, 110 respectively are integrated with the main sheet 102 at the two fold regions 104, 106. The main sheet 102 is configured for being bent in the directions 134, 136 shown in FIG. 1 to move the two fold regions 104, 106 toward each other. The main sheet 102 is also configured for retaining a bias for moving the two fold regions 104, 106 away from each other in the directions 138, 140 shown in FIG. 1. The main sheet 102 may have a structural memory for a conformation as shown in FIG. 2, where the first side 112 and the second opposite side 114 shown in FIG. 1 both are substantially planar. In an example, both of the flap sheets 108, 110 may be in contact with the first side 112 of the main sheet 102, as shown in FIG. 2.

FIG. 3 is another plan view of the device 100 shown in FIGS. 1 and 2. In the view shown in FIG. 3, the two flap sheets 108, 110 of the device 100 have been unfolded away from the main sheet 102 in the directions 144, 146 as shown in FIG. 1; and are substantially coplanar with the main sheet 102. The main sheet 102 may have a structural memory for a conformation where the first side 112 and the second opposite side 114 (shown in FIG. 1) of the main sheet 102 both are substantially planar. In an example, the fold regions 104, 106 may include perforations 302. In another example, the fold regions 104, 106 may be scored along the dotted lines 304. The perforations 302, or the scoring along dotted lines 304, or both, may in examples facilitate folding the flap sheets 108, 110 along the fold regions 104, 106.

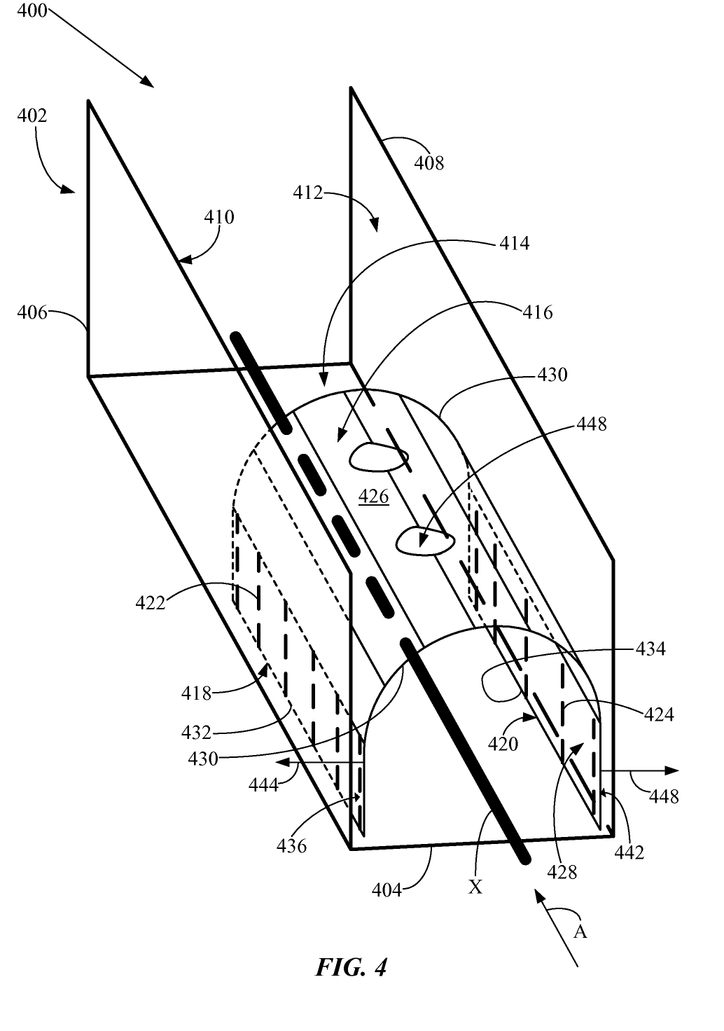

FIG. 4 is a perspective view showing an example 400 of an implementation of an apparatus. The apparatus 400 includes a trough 402 having a base member 404 integrated with two spaced-apart wall members 406, 408, the wall members 406, 408 respectively forming side walls 410, 412 inside the trough 402. The trough 402 may, for example, function as a cable carrier suitable for holding one or more signal cables X, power cables X, or both. The apparatus 400 further includes a device 414 having a flexible main sheet 416, two fold regions 418, 420, and two flexible flap sheets (not shown) respectively spanning the spaces schematically marked by dashed lines 422, 424. The main sheet 416 has first and second opposite sides 426, 428. The main sheet 416 has an edge 430 surrounding both of the first and second opposite sides 426, 428. The two fold regions 418, 420 respectively are located along two spaced-apart portions 432, 434 of the edge 430. The flap sheet 422 has first and second opposite sides including side 436 and another side (not shown); and the flap sheet 424 has first and second opposite sides including side 440 and another side (not shown). The flap sheets 422, 424 respectively are integrated with the main sheet 416 at the two fold regions 418, 420. The side 436 of the flap sheet 422 is in contact with the side wall 410 of the trough 402; and the side 442 of the flap sheet 424 is in contact with the side wall 412 of the trough 402. The main sheet 416 is bent, with the fold regions 418, 420 partially positioned toward each other. The main sheet 416 is configured for retaining a bias for moving the fold regions 418, 420 away from each other in directions of arrows 444, 446. In an example, both of the flap sheets 422, 424 may be, as shown in FIG. 4, in contact with the first side 426 of the main sheet 416. As another example, a cable X may be positioned in the trough 402, the main sheet 416 of the device 414 may be placed over the cable X in the trough 402, and the flap sheets 422, 424 may respectively be placed in contact with the side walls 410, 412 in the trough 402. It is understood that a plurality of cables X may be likewise positioned in the trough 402.

As an example, the device 414 may include one or more grips 448 in the main sheet 416, each grip 448 being spaced apart from the edge 430 and communicating with the first and second opposite sides 426, 428 of the main sheet 416. In further examples, the grip 142 may include a ring attached to the main sheet 416 and having an aperture oriented generally perpendicular to the first side 426, or a handle attached to the main sheet 416. As an additional example, the main sheet 416 may have a structural memory for a conformation where each of the first and second opposite sides 426, 428 of the main sheet 416 is substantially planar. As further examples (not shown), the fold regions 418, 420 of the device 414 may be scored, or include perforations, or both, in the same manner as earlier discussed with regard to the device 100 and as shown in FIG. 3.

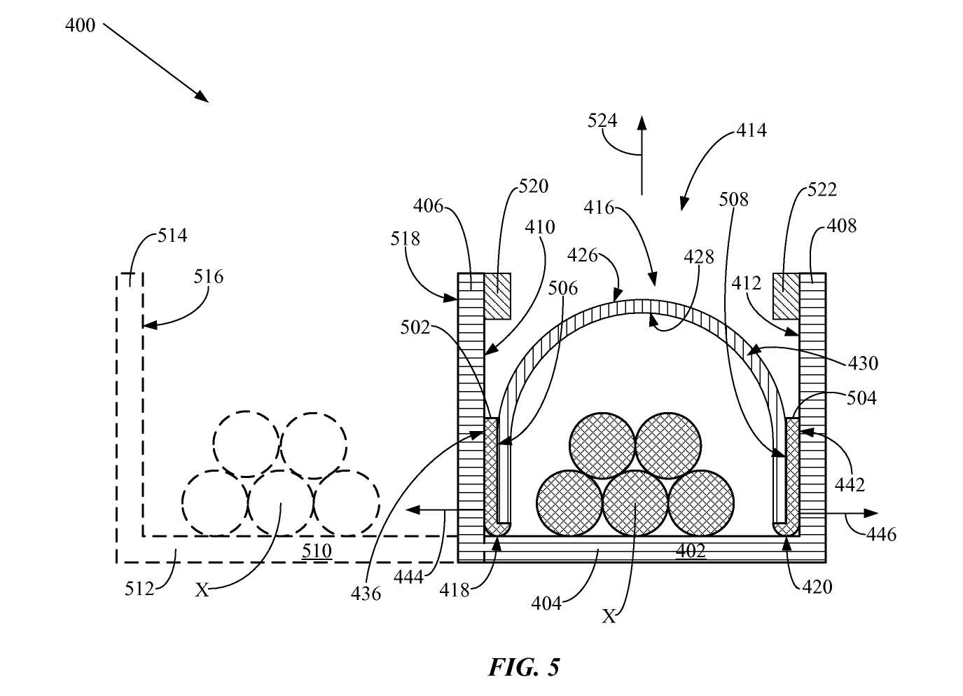

FIG. 5 is a cross-sectional view taken along line A, showing the apparatus 400 of FIG. 4. The apparatus 400 includes a trough 402 having a base member 404 integrated with two spaced-apart wall members 406, 408, the wall members 406, 408 respectively forming side walls 410, 412 inside the trough 402. The trough 402 may, for example, function as a cable carrier suitable for holding one or more signal cables X, power cables X, or both. The apparatus 400 further includes a device 414 having a flexible main sheet 416, two fold regions 418, 420, and two flexible flap sheets 502, 504 respectively corresponding to the schematic representations of the flexible flap sheets marked in FIG. 4 by dashed lines 422, 424. The main sheet 416 has first and second opposite sides 426, 428. The main sheet 416 has an edge 430 surrounding both of the first and second opposite sides 426, 428. The two fold regions 418, 420 respectively are located along two spaced-apart portions 432, 434 shown in FIG. 4, of the edge 430. The flap sheet 502 has first and second opposite sides 436, 506; and the flap sheet 504 has first and second opposite sides 442, 508. The flap sheets 502, 504 respectively are integrated with the main sheet 416 at the two fold regions 418, 420. The side 436 of the flap sheet 502 is in contact with the side wall 410 of the trough 402; and the side 442 of the flap sheet 504 is in contact with the side wall 412 of the trough 402. The main sheet 416 is bent, with the fold regions 418, 420 partially positioned toward each other. The main sheet 416 is configured for retaining a bias for moving the fold regions 418, 420 away from each other in directions of arrows 444, 446. In an example, both of the flap sheets 502, 504 may be, as shown in FIG. 5, in contact with the first side 426 of the main sheet 416. As another example, a plurality of cables X may be positioned in the trough 402, the main sheet 416 of the device 414 may be placed over the cables X in the trough 402, and the flap sheets 502, 504 may respectively be placed in contact with the side walls 410, 412 in the trough 402. It is understood that any selected quantity of one or more cables X may be likewise positioned in the trough 402.

In an example, the trough 402 may be designated as a first trough 402, and the apparatus 400 may include a second trough represented by a dotted line 510, adjacent to the first trough 402. In that example, the second trough 510 may for example include a base member 512 and a wall member 514. The wall member 514 and the wall member 406 may, in that example, respectively form side walls 516, 518 in the second trough 510. Further in that example, the first trough 402 and the second trough 510 may collectively form a cable carrier. The cable carrier 402, 510 may include a base member collectively formed by the base members 404, 512 integrated with first and second spaced-apart side wall members 408, 514, the carrier 402, 510 including a central wall member 406 on the base member 404, 512 between the side wall members 408, 514. The central wall member 406 may form the side walls 410, 518 of the first and second troughs 402, 510, respectively.

As an example, the side walls 410, 412 of the trough 402 may respectively include lips 520, 522. The lips 520, 522 may, for example, resist or prevent removal of the device 414 from the trough 402 in the direction represented by an arrow 524. Further, for example, the device 414 may in that case be removed from the trough 402 by sliding the device 414 out of the trough longitudinally along the cable X.

In an example, either or both of the first and second troughs 402, 510 may function as a cable carrier suitable for holding one or more signal cables X, power cables X, or both. For example, the first trough 402 including the device 414 may be utilized for holding one or a plurality of a first type of cables X, and the second trough 510 may be utilized for holding one or a plurality of a second type of cables X. As an example, the first type of cables X may include cables designated, relatively to the second type of cables X, as being fragile, or otherwise to be less frequently disturbed. For example, the first type of cables X may include fiber optic cables, and the second type of cables X may include metallic conductor cables.

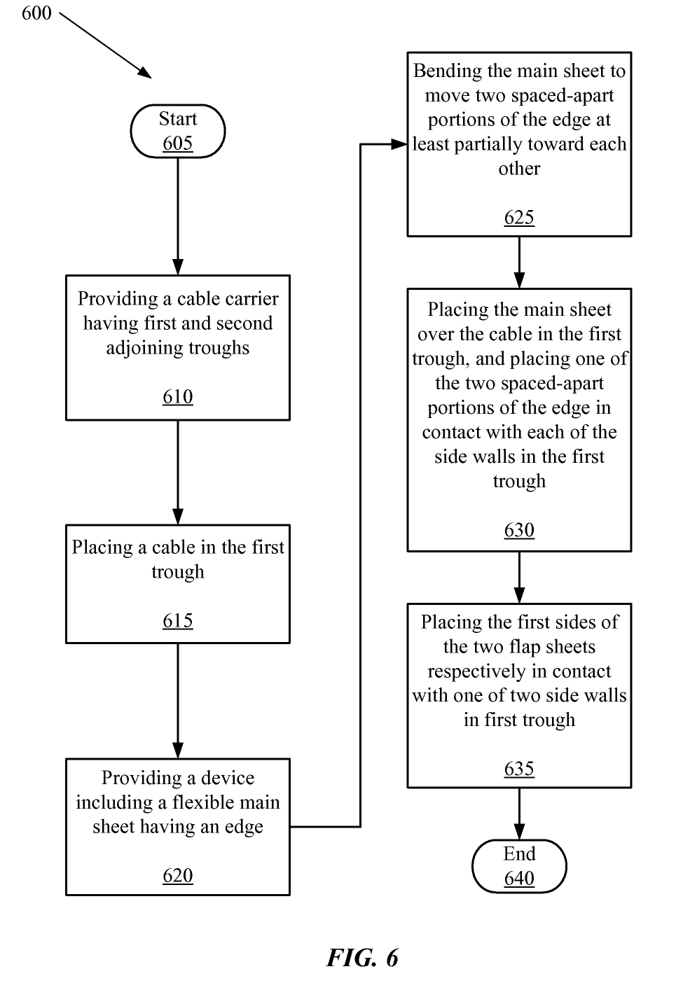

FIG. 6 is a flow chart showing an example 600 of an implementation of a method. The method starts at step 605. Step 610 includes providing a cable carrier, having first and second adjoining troughs, the carrier including a base member integrated with first and second spaced-apart side wall members, the carrier including a central wall member on the base member between the side wall members, the first side wall member and the central wall member each forming a side wall in the first trough. At step 615, a cable X is placed in the first trough. Step 620 includes providing a device including a flexible main sheet, the main sheet having first and second opposite sides and having an edge surrounding both of the first and second sides. At step 625, the main sheet is bent to move two spaced-apart portions of the edge at least partially toward each other. Step 630 includes placing the main sheet over the cable in the first trough, and placing one of the two spaced-apart portions of the edge in contact with each of the side walls in the first trough. The method may then end at step 640.

In an example, providing the device at step 620 may include: providing two fold regions being respectively located along the two spaced-apart portions of the edge; and providing two flexible flap sheets each having first and second opposite sides, each of the flap sheets being integrated with the main sheet at one of the two fold regions. Further in that example, the method 400 may include, at step 635, placing the first sides of the two flap sheets respectively in contact with the two side walls in the first trough. Further in that example, providing the carrier at step 610 may include providing a lip on each of the two side walls facing into the first trough; and step 635 may include utilizing the lips to restrict a range of mobility of each of the two flap sheets in the first trough.

In a further example, providing the device at step 620 may include providing a grip (not shown) spaced apart from the edge and located on the first side of the main sheet, the grip being configured for applying a pulling force to the first side of the main sheet; and step 635 may include utilizing the grip for removing the main sheet from the first trough.

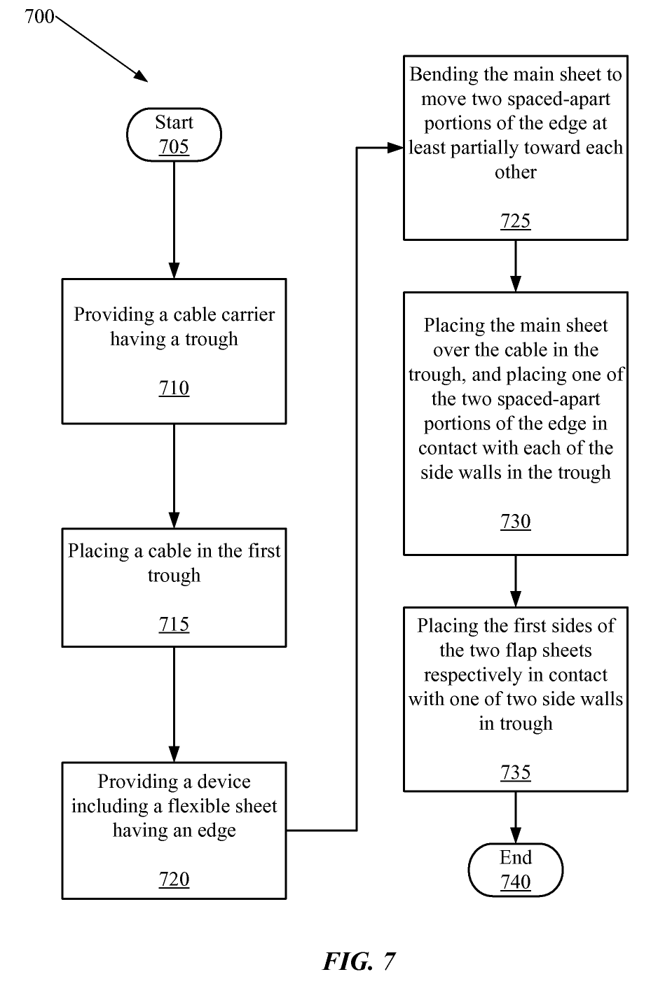

FIG. 7 is a flow chart showing another example 700 of the method. The method 700 starts at step 705. Step 710 includes providing a cable carrier having a trough, the carrier including a base member integrated with first and second spaced-apart side wall members each forming a side wall in the trough. At step 715, a cable X is placed in the trough. Step 720 includes providing a device including a flexible main sheet, the main sheet having first and second opposite sides and having an edge surrounding both of the first and second sides. At step 725, the main sheet is bent to move two spaced-apart portions of the edge at least partially toward each other. Step 730 includes placing the main sheet over the cable in the trough, and placing one of the two spaced-apart portions of the edge in contact with each of the side walls in the trough. The method may then end at step 740.

In an example, providing the device at step 720 may include: providing two fold regions being respectively located along the two spaced-apart portions of the edge; and providing two flexible flap sheets each having first and second opposite sides, each of the flap sheets being integrated with the main sheet at one of the two fold regions. Further in that example, the method 700 may include, at step 735, placing the first sides of the two flap sheets respectively in contact with the two side walls in the trough. Further in that example, providing the carrier at step 710 may include providing a lip on each of the two side walls facing into the first trough; and step 730 may include utilizing the lips to restrict a range of mobility of each of the two flap sheets in the trough.

In a further example, providing the device at step 720 may include providing a grip (not shown) spaced apart from the edge and located on the first side of the main sheet, the grip being configured for applying a pulling force to the first side of the main sheet; and step 735 may include utilizing the grip for removing the main sheet from the trough.

It is understood throughout this specification by those skilled in the art that the device 100 and the apparatus 400 may include various modifications as discussed above and illustrated by the figures. It is further understood that the device 100 may be modified according to the above teachings with regard to the apparatus 400, and that the apparatus 400 may be modified according to the above teachings with regard to the device 100. Likewise, the method 600 may be modified according to the above teachings with regard to the method 700. Further, the devices 100, 400 may be modified according to the above teachings with regard to the methods 600, 700, and vice versa. Therefore, as to the above discussions of each of the device 100, the apparatus 400, and the methods 600, 700, all of the teachings of the other such aspects of this disclosure are deemed incorporated in the discussions of the device 100, apparatus 400, and methods 600, 700.

The device 100 may, for example, be utilized in a trough as a retainer for one or a plurality of signal or power cables or both, such as fiber-optic cables and metallic conductor cables. Likewise, the apparatus 400 may, for example, be utilized as a retainer for one or a plurality of signal or power cables, or both. Further, the methods 600, 700 may be utilized in connection with a device including a flexible main sheet as described herein, of which the device 100 and the apparatus 400 are only examples. While the foregoing description refers in some instances to the device 100 and apparatus 400, it is appreciated that the subject matter is not limited to these structures, nor to the structures discussed in the specification. Other configurations of devices and apparatus may be utilized consistent with the teachings herein. Likewise, the methods 600, 700 may include additional steps and modifications of the indicated steps.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A device, comprising:
a flexible main sheet having first and second opposite sides and an edge surrounding both of the first and second sides;
two fold regions, the two fold regions being respectively located along two spaced-apart portions of the edge; and
two flexible flap sheets each having first and second opposite sides, the flap sheets respectively being integrated with the main sheet at the two fold regions;
wherein both of the flap sheets are configured for being bent toward the first side of the main sheet; and
wherein the main sheet is configured for being bent to move the two fold regions toward each other, while retaining a bias for moving the two fold regions away from each other.

2. The device of claim 1, wherein the main sheet has a structural memory for a conformation where each of the first and second opposite sides of the main sheet is substantially planar.

3. The device of claim 1, wherein both of the flap sheets are in contact with the first side of the main sheet.

4. The device of claim 1, wherein the fold regions are scored.

5. The device of claim 1, wherein the fold regions include perforations.

6. The device of claim 1, including a grip spaced apart from the edge and located on the first side of the main sheet, the grip being configured for applying a pulling force to the first side of the main sheet.

7. The device of claim 6, wherein the grip includes an aperture in the main sheet, the aperture being spaced apart from the edge and communicating with the first and second opposite sides of the main sheet.

8. An apparatus, comprising:
a trough including a base member integrated with two spaced-apart wall members, each of the wall members forming a side wall in the trough; and
a device including a flexible main sheet, two fold regions, and two flexible flap sheets;
the main sheet having first and second opposite sides, and having an edge surrounding both of the first and second opposite sides;
each of the flap sheets having first and second opposite sides;
wherein the fold regions respectively are located along two spaced-apart portions of the edge, and the flap sheets respectively are integrated with the main sheet at the two fold regions;
wherein the first sides of the two flap sheets are respectively in contact with the two side walls of the trough;
wherein the main sheet is bent, with the fold regions at least partially positioned toward each other; and
wherein the main sheet is configured for retaining a bias for moving the fold regions away from each other.

9. The apparatus of claim 8, wherein the main sheet has a structural memory for a conformation where each of the first and second opposite sides of the main sheet is substantially planar.

10. The apparatus of claim 8, wherein both of the flap sheets are in contact with the first side of the main sheet.

11. The apparatus of claim 8, wherein the fold regions are scored.

12. The apparatus of claim 8, wherein the fold regions include perforations.

13. The apparatus of claim 8, including a grip spaced apart from the edge and located on the first side of the main sheet, the grip being configured for applying a pulling force to the first side of the main sheet.

14. The apparatus of claim 13, wherein the grip includes an aperture in the main sheet, the aperture being spaced apart from the edge and communicating with the first and second opposite sides of the main sheet.

15. A method, including:
providing a cable carrier having first and second adjoining troughs, the carrier including a base member integrated with first and second spaced-apart side wall members, the carrier including a central wall member on the base member between the side wall members, the first side wall member and the central wall member each forming a side wall in the first trough;
placing a cable in the first trough;
providing a device including a flexible main sheet, the main sheet having first and second opposite sides and having an edge surrounding both of the first and second sides;
bending the main sheet to move two spaced-apart portions of the edge at least partially toward each other; and
placing the main sheet over the cable in the first trough, and placing one of the two spaced-apart portions of the edge in contact with each of the side walls in the first trough.

16. The method of claim 15, wherein
providing the device includes providing two fold regions being respectively located along the two spaced-apart portions of the edge;
providing the device includes providing two flexible flap sheets each having first and second opposite sides, each of the flap sheets being integrated with the main sheet at one of the two fold regions; and
the method includes placing the first sides of the two flap sheets respectively in contact with the two side walls in the first trough.

17. The method of claim 16, wherein:
providing the carrier includes providing a lip on each of the two side walls facing into the first trough; and
the method includes utilizing the lips to restrict a range of mobility of each of the two flap sheets in the first trough.

18. The method of claim 15, wherein:
providing the device includes providing an aperture spaced apart from the edge and communicating with the first and second opposite sides of the main sheet; and
the method includes utilizing the aperture for removing the main sheet from the first trough.

19. The method of claim 15, wherein:
providing the device includes providing a grip spaced apart from the edge and located on the first side of the main sheet, the grip being configured for applying a pulling force to the first side of the main sheet; and
the method includes utilizing the grip for removing the main sheet from the first trough.

20. A method, including:
providing a cable carrier having a trough, the carrier including a base member integrated with first and second spaced-apart side wall members each forming a side wall in the trough;
placing a cable in the trough;
providing a device including a flexible main sheet, the main sheet having first and second opposite sides and having an edge surrounding both of the first and second sides;
bending the main sheet to move two spaced-apart portions of the edge at least partially toward each other; and
placing the main sheet over the cable in the trough, and placing one of the two spaced-apart portions of the edge in contact with each of the side walls in the trough.
